(19) United States
(12) Patent Application Publication
(10) Pub. No.: US 2018/0115667 A1
(43) Pub. Date: Apr. 26, 2018

(54) SYSTEM AND METHOD FOR GAMIFICATION OF MULTIFUNCTION PERIPHERALS

(71) Applicants: Kabushiki Kaisha Toshiba, Minato-ku (JP); Toshiba TEC Kabushiki Kaisha, Shinagawa-ku (JP)

(72) Inventors: Marianne KODIMER, Huntington Beach, CA (US); Louis ORMOND, Irvine, CA (US)

(21) Appl. No.: 15/692,351

(22) Filed: Aug. 31, 2017

Related U.S. Application Data
(60) Provisional application No. 62/410,534, filed on Oct. 20, 2016.

(51) Int. Cl. H04N 1/00; A63F 13/2145; A63F 9/18

(52) U.S. Cl. CPC H04N 1/00514; H04N 1/00411; H04N 1/00424; G06F 3/04883; A63F 9/181; H04N 2201/0094; H04N 1/00474; A63F 13/2145

(57) ABSTRACT

A system and method for gamification of multifunction peripherals includes a document processing engine for rendering printed output from electronic image files. An intelligent controller of the MFP controls operation of a document processing engine. A sequence of user interactive graphical images of tangible objects is generated on a device touchscreen interface. User touchscreen input responsive to the sequence of graphical images generates a random Omikuji fortune that is displayed to the user on the device touch screen interface. Device control instructions corresponding to user touchscreen input are generated and these instructions control operation of the document processing engine.

### RELATED APPLICATIONS

This application claims the benefit of U.S. Provisional Application No. 62/410,534, filed Oct. 20, 2016, which is incorporated herein by reference.

### TECHNICAL FIELD

This application relates generally to multifunction peripherals with a gamification interface. This application relates more particularly to a multifunction peripheral with enhanced usability to generate user fortunes with touchscreen interaction with a virtual depiction of a Japanese Omikuji fortune sequence.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs are essential business tools it a modern office environment. Earlier devices employed discrete mechanical switches or buttons for user device control. As MFPs became more powerful and configurable, device control was accomplished by an on-board computer referred to as an intelligent controller. A controller can be programmed to control MFP functions such as scanning, printing, or copying. A copying operation could be accomplished by controlling the scanner and printer sequentially. Controllers could also function to enable additional device functions such as stapling or hole punching. Increased device functionality lead to a menu driven, touchscreen user interface to enable a user to easily configure an MFP to accomplish a desired document processing job.

### SUMMARY

In accordance with an example embodiment of the subject application, a system and method for gamification of multifunction peripherals includes a document processing engine for rendering printed output from electronic image files. An intelligent controller of the MFP controls operation of a document processing engine. A sequence of user interactive graphical images of tangible objects is generated on a device touchscreen interface. Device control instructions corresponding to user touchscreen input responsive to the sequence of graphical images are generated and these instructions control operation of the document processing engine.

### BRIEF DESCRIPTION OF THE DRAWINGS

Various embodiments will become better understood with regard to the following description, appended claims and accompanying drawings wherein:

FIG. 1 an example embodiment of a multifunction peripheral gamification system;

FIG. 2 is an example embodiment of a user interface screen depicting a virtual omikuji box;

FIG. 3 is an example embodiment of a user interface screen depicting a user touching of a virtual omikuji box;

FIG. 4 is an example embodiment of a user interface screen depicting an omikuji box image along with stick image showing a randomly generated number;

FIG. 5 is an example embodiment of a user interface screen depicting a fortune retrieved from a device memory;

FIG. 6 is an example embodiment of a user interface screen depicting a hard copy printout of a fortune;

FIG. 7 is an example embodiment of a networked digital device such as a multifunction peripheral; and

FIG. 8 is a flowchart of an example embodiment of operations for accomplishing gamification on a multifunction peripheral.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFPs are powerful and essential business tools. However, user interaction is straightforward and accomplished with touchscreen menus that are solely geared toward accomplishing a typical document processing operation, such as scanning, printing or copying. While functional, touchscreen device interfaces are extremely unengaging for users, particularly when a user uses a device regularly for the same or similar tasks. The subject application teaches example embodiments of MFPs that accomplish device control in a gamification context. Gamification includes an application of typical elements of game playing (e.g., point scoring, competition with others, rules of play) to other areas of activity to encourage engagement with a product or service. Enhanced user/device interaction is realized with application of game-design elements and game principles in non-game contexts.

In one example embodiment, an MFP is provided with a gamification interface that enables an MFP to mimic Japanese Omikuji, which are random fortunes written on strips of paper at Shinto shrines and Buddhist temples in Japan. Meaning “sacred lot,” these are usually received by making a small offering and randomly choosing one from a box, hoping for the resulting fortune to be good. The way one obtains omikuji can feel like a lottery drawing. Traditionally one shook a small box containing numbered bamboo sticks until one fell out. The stick had a number on it and according to the number you were given an omikuji by a priest or Miko. This is still possible nowadays, but more common are boxes that are located somewhere on the temple/shrine ground. Fortunes are also picked from a drawer corresponding to the number on the drawn bamboo stick.

MFPs, via their intelligent controllers, are suitably configured to provide an enhanced user experience with gamification, such as by mimicking an omikuji experience.

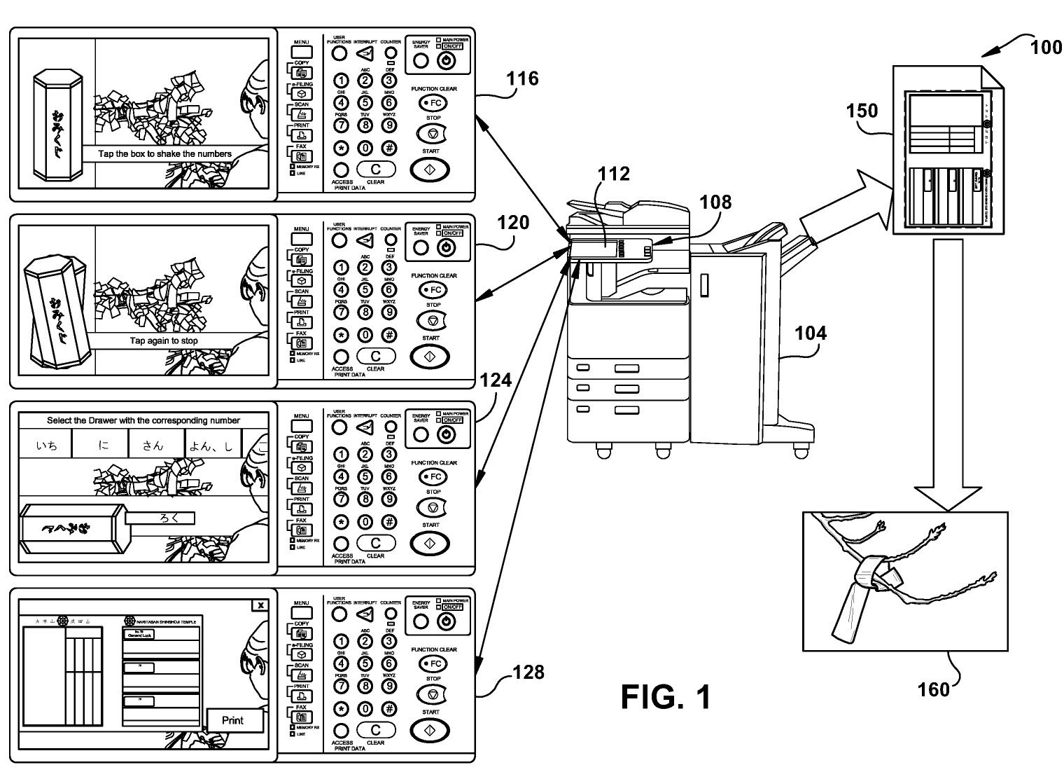

In accordance with the subject application, FIG. 1 illustrates an example embodiment of a gamification system 100 running on MFP 104. MFP 104 includes a user interface 108 including a touch screen 112 configured to generate graphical or text images, and suitably programmable to generate a soft keyboard for numeric or text entry. In the illustrated example embodiment, gamification of MFP 104 is accomplished by generation of a series of user interface rendering 116, 120, 124 and 128.

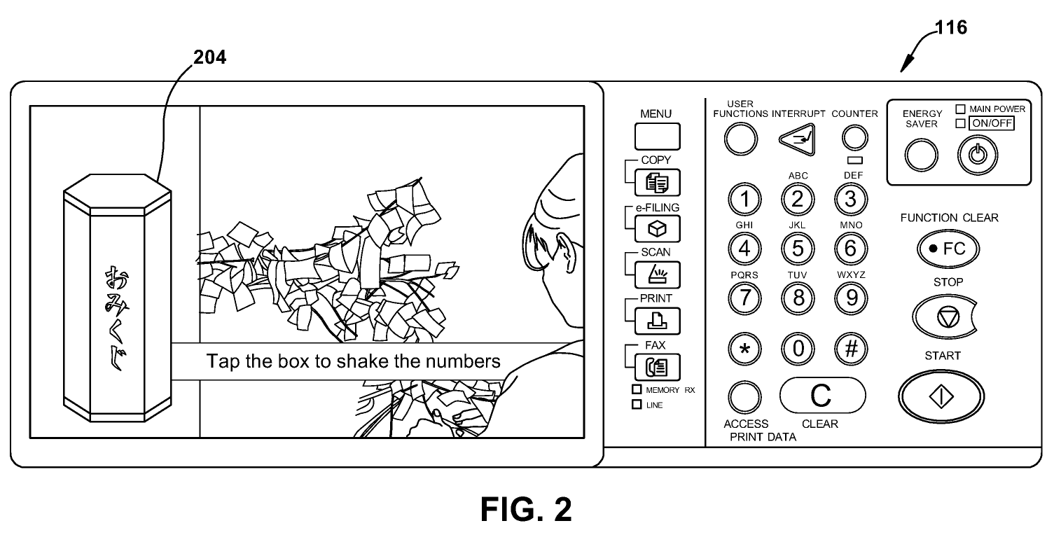

Interface rendering 116, with added reference to FIG. 2, includes a graphical rendering of a container or box 204, suitably virtually depicting an omikuji box. A user is prompted to tap the touchscreen portion depicting box 204, suitably by tapping the image or sliding one's finger on it in to virtually shake it.

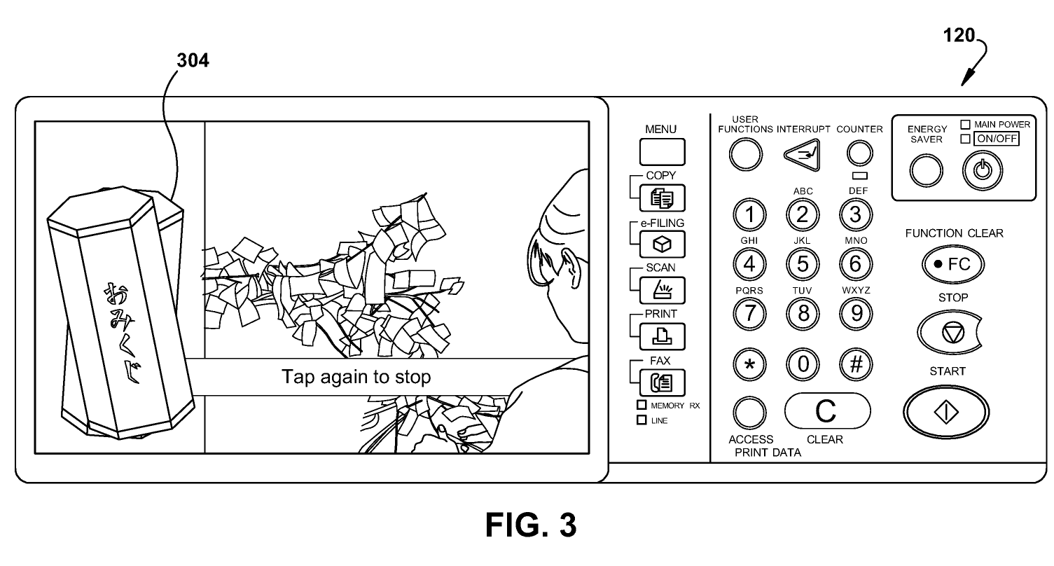

Next, with added reference to FIG. 3, interface rendering 120 depicts shaking box image 304, suitably corresponding to a touch of box 204 of FIG. 2 as described above. In the example, responsive to a prompt, a user touches image 304 to cease its shaking.

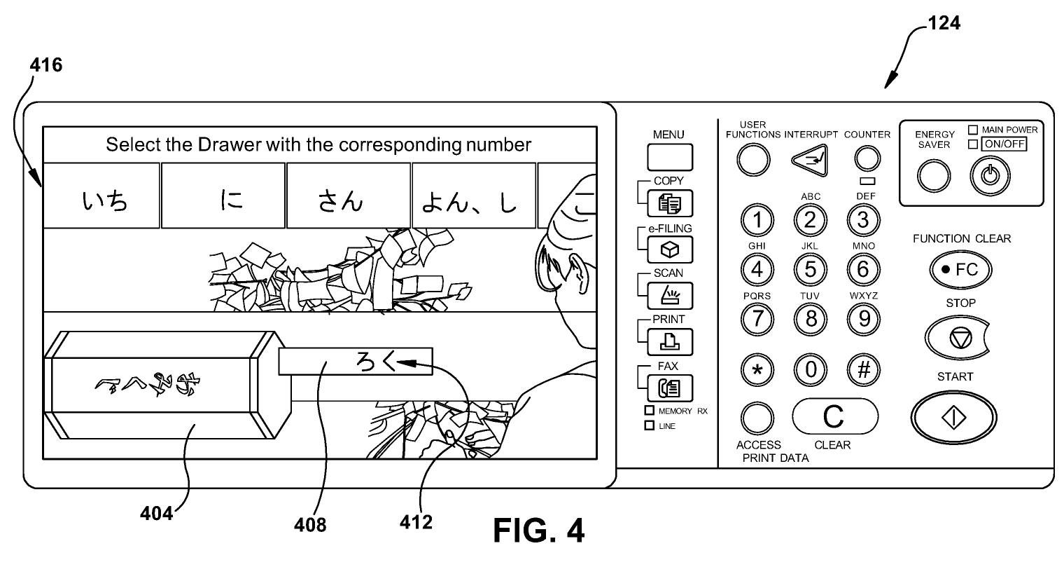

Next, with added reference to FIG. 4, interface rendering 124 depicts box image 404 along with stick image 408 showing a randomly generated number 412, the randomly generated number 412 is suitably generated from a seed value formed from user input, such as a duration of the shaking of the box. A series of images of numbered, virtual drawers 416 are also generated with each drawer bearing a number. Drawers 416 are suitably scrollable to reveal additional, numbered drawers, such as by swiping a finger left to right across the display over displayed drawers 416. When a drawer 416 bearing the randomly generated number 412 on the stick image 408 is selected, then a virtual omikuji fortune will be drawn. If a drawer with an unmatching number is selected, the user is prompted to seek and select the correct drawer.

Traditional omikuji fortunes include a general blessing which can be any one of the following:
Great blessing (dai-kichi)
Middle blessing (chū-kichi)
Small blessing (shō-kichi)
Blessing (kichi)
Half-blessing (han-kichi)
Ending blessing (sue-kichi)
Ending small blessing (sue-shō-kichi)
Curse (kyō)
Small curse (shō-kyō)
Half-curse (han-kyō)
Ending curse (sue-kyō)
Great curse (dai-kyō)

Traditional fortunes then list specific aspects of one's life, which may include any number of the following among other possible combinations:
(hōgaku)—auspicious/inauspicious directions
(negaigoto)—one's wish or desire
(machibito)—a person being waited for
(usemono)—lost article(s)
(tabidachi)—travel
akinai)—business dealings
(gakumon)—studies or learning
(sōba)—market speculation
(arasoigoto)—disputes
(ren'ai)—romantic relationships
(tenkyo)—moving or changing residence
(shussan)—childbirth, delivery
(byōki)—illness
(endan)—marriage proposal or engagement

All of the forgoing are suitably stored in and MFP device storage, detailed further below, for retrieval.

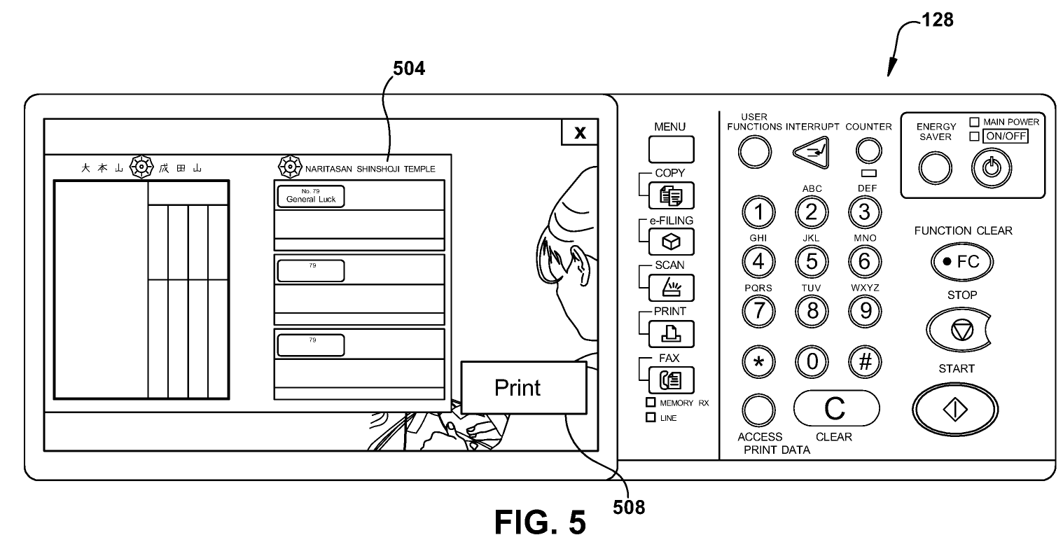

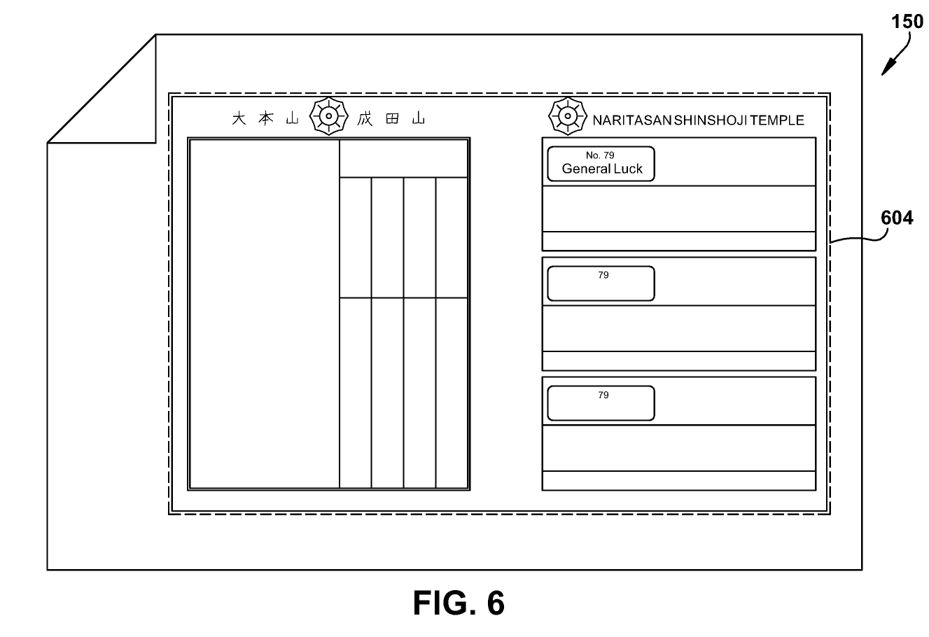

Next, with added reference to FIG. 5, interface rendering 128 depicts a fortune 504 retrieved from a plurality of fortune images stored in MFP memory corresponding to the selected drawer. The user may choose to print a hard copy 150 of their fortune by depressing touchscreen button 508. If printing is selected, a hard copy 150 of fortune 504 is printed as depicted by FIGS. 1 and 6, suitably on specialized paper selected from an associated paper source, such as a particular paper tray. Specialized paper, suitably printing on a paper strip, facilitates folding the printed fortune for placement on an object such as a tree or wall, illustrated by fixing to a tree 160 as shown in FIG. 1.

Omikuji fortunes are typically printed on paper for future placement. When the prediction is bad, it is a custom to fold up the strip of paper and attach it to a pine tree or a wall of metal wires alongside other bad fortunes in the temple or shrine grounds. A purported reason for this custom is a pun on the word for pine tree (matsu) and the verb “to wait” (also matsu), the idea being that the bad luck will wait by the tree rather than attach itself to the bearer. In the event of the fortune being good, a bearer typically has two options: he or she can also tie it to the tree or wires so that the fortune has a greater effect or he or she can keep it for luck. Thus, printing of a fortune on specialized paper or stock, such as a strip paper or paper scored for cutting, would be advantageous. Alternatively, scoring 604 may be supplied by generation of a corresponding printed image on hard copy 150.

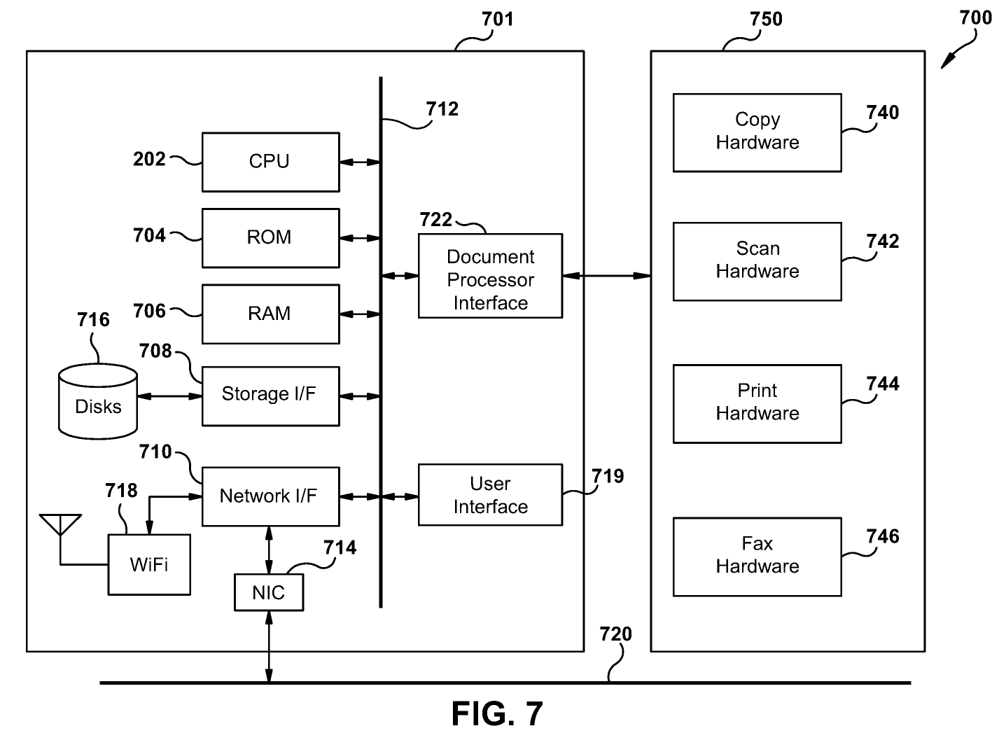

Turning now to FIG. 7 illustrated is an example embodiment of a networked digital device comprised of document rendering system 700 suitably comprised within an MFP, such as with MFP 104 of FIG. 1. Included in controller 701 are one or more processors, such as that illustrated by processor 702. Each processor is suitably associated with non-volatile memory, such as ROM 704, and random access memory (RAM) 706, via a data bus 712.

Processor 702 is also in data communication with a storage interface 708 for reading or writing to a storage 716, suitably comprised of a hard disk, optical disk, solid-state disk, cloud-based storage, or any other suitable data storage as will be appreciated by one of ordinary skill in the art.

Processor 702 is also in data communication with a network interface 710 which provides an interface to a network interface controller (NIC) 714, which in turn provides a data path to any suitable wired or physical network connection 720, or to a wireless data connection via wireless network interface 718. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 702 is also in data communication with one or more sensors which provide data relative to a state of the device or associated surroundings, such as device temperature, ambient temperature, humidity, device movement and the like.

Processor 702 can also be in data communication with any suitable user input/output (I/O) interface 719 which provides data communication with user peripherals, such as displays, keyboards, mice, track balls, touch screens, or the like.

Also in data communication with data bus 712 is a document processor interface 222 suitable for data communication with MFP functional units 750. In the illustrate example, these units include copy hardware 740, scan hardware 742, print hardware 744 and fax hardware 746 which together comprise MFP functional hardware 750. Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. It will be understood that functional units are suitably comprised of intelligent units, including any suitable hardware or software platform.

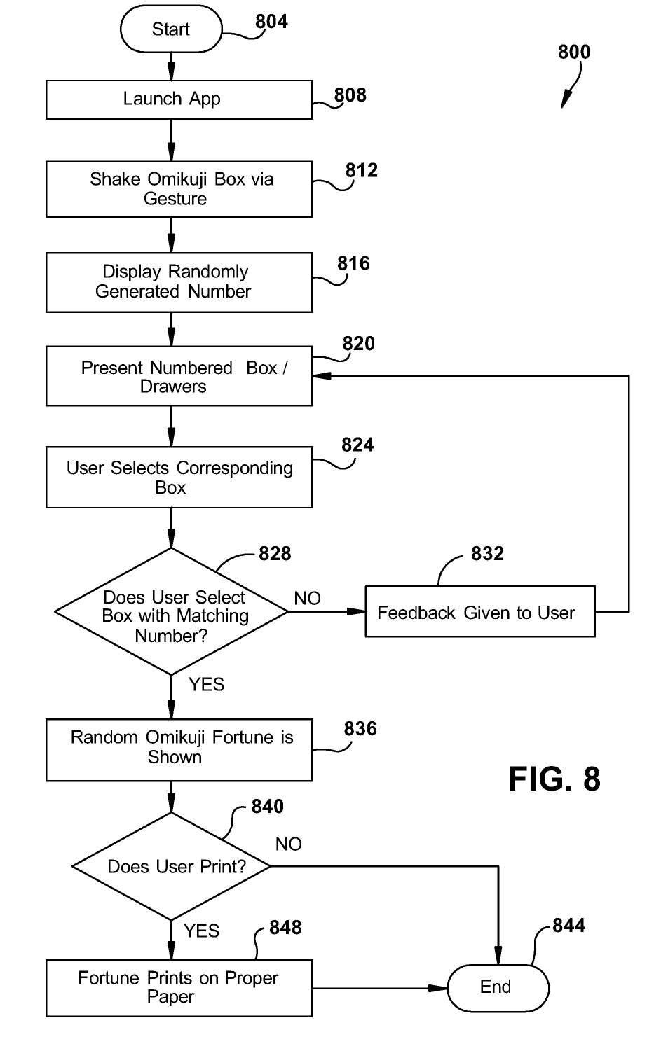

Referring next to FIG. 8, illustrated is an example embodiment of a flowchart 800 for accomplishing the forgoing on an MFP by use of its associated controller. The process commences at block 804 with an application launch at block 808. A user gesture on an MFP touch screen generates a shaking image of an omikuji box at block 812 and a random number is generated and displayed at block 816. Next, a rendering of numbered drawers on the touch screen is made at block 820, and a user selects a box by depressing its image at block 824. If it is determined at block 828 that the user's selection does not coincide with the generated random number, feedback, such as an error message or “try again,” is displayed on the touch screen at block 632 and the process returns to block 820. If the numbers match, then a random fortune is displayed at block 836. If the user chooses not to print out the fortune at block 840, the process ends at block 844. Otherwise the fortune is printed on proper paper at block 848 before the process ends at block 844.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A document processing system comprising:
a document processing engine configured to render printed output from electronic image files;
an intelligent controller including a processor and memory, the controller configured for controlled operation of the document processing engine; and
a touchscreen user interface,
wherein the processor is configured to generate a sequence of user interactive graphical images of tangible objects on the touch screen;
wherein the processor is further configured to generate device control instructions corresponding to user touchscreen input responsive to the sequence of graphical images; and
wherein the processor is further configured to control operation of the document processing engine in accordance with generated device control instructions.

2. The document processing system of claim 1 wherein the device control instructions include instructions to print a tangible copy of an electronic document corresponding to the user touchscreen input.

3. The document processing system of claim 2 wherein the device control instructions include instructions to print the tangible copy with visible content corresponding to the user touchscreen input.

4. The document processing system of claim 2 wherein the device control instructions include instructions to print the tangible copy with visible content comprising a random graphical image retrieved from the memory.

5. The document processing system of claim 4 wherein the device control instructions include instructions to print the tangible copy with the visible content comprising a user fortune.

6. The document processing system of claim 2 wherein the device control instructions are generated in accordance a plurality of discrete touches on the touch screen.

7. The document processing system of claim 2 wherein the device control instructions are generated in accordance with a sliding touch along a surface of the touch screen.

8. A method comprising:
storing, in memory, electronic image files;
controlling operation of a document processing engine configured to render printed output via an intelligent controller having a processor and memory;
generating a sequence of user interactive graphical images of tangible objects on a touchscreen user interface of an associated touch screen;
receiving, via the touchscreen interface, user touchscreen input responsive to the sequence of graphical images;
generating, via the intelligent controller, device control instructions corresponding to the user touchscreen input; and
controlling operation of the document processing engine, via the controller, in accordance with generated device control instructions.

9. The method of claim 8 further comprising printing a tangible copy of an electronic document corresponding to the user touchscreen input.

10. The method of claim 9 further comprising printing the tangible copy with visible content corresponding to the user touchscreen input.

11. The method of claim 9 wherein further comprising printing the tangible copy with visible content comprising a random graphical image retrieved from the electronic image files in the memory.

12. The method of claim 11 further comprising printing the tangible copy with the visible content comprising a user fortune.

13. The method system of claim 9 further comprising generating the device control instructions in accordance a plurality of discrete touches on the touch screen.

14. The method of claim 9 further comprising generating the device control instructions in accordance with a sliding touch along a surface of the touch screen.

15. A multifunction peripheral comprising:
a document processing engine configured to render printed output from electronic image files;
an intelligent controller including a processor and memory, the controller configured for controlled operation of the document processing engine; and
a touchscreen user interface,
wherein the memory stores a plurality of electronic documents corresponding to user fortunes,
wherein the processor is configured to generate a container image on the touch screen,
wherein the processor is further configured to receive touch input from the touch screen corresponding to a position of the container image,
wherein the processor is further configured to generate a random number,
wherein the processor is further configured to render an image of a generated random number on the touch screen;
wherein the processor is further configured to receive numerical user input via the touch screen,
wherein the processor is further configured to compare received numerical user input with the random number, and
wherein the processor is further configured to selectively control operation of the document processing engine to print an electronic document in accordance with a comparison of the numerical user input with the random number.

16. The multifunction peripheral of claim 15 wherein the processor is further configured to generate an error message on the touch screen when the numerical user input does not match the random number.

17. The multifunction peripheral of claim 16 wherein the processor is further configured to generate an image of the electronic document on the touch screen prior to printing the electronic document.

18. The multifunction peripheral of claim 17 wherein the processor is further configured to selectively print the electronic document upon receipt of a print request via the touch screen.

19. The multifunction peripheral of claim 18 wherein the processor is further configured to print the electronic document on a paper retrieved from a paper strip tray.

20. The multifunction peripheral of claim 19 wherein the processor is further configured to generate the image of the random number superimposed on an image of a stick.
